(19) United States
(12) Patent Application Publication
(10) Pub. No.: US 2024/0417285 A1
(43) Pub. Date: Dec. 19, 2024

(54) MONOVALENT ANION SELECTIVE MEMBRANE ENABLED BY HIGH CONCENTRATION BRINE

(71) Applicant: ENERGY EXPLORATION TECHNOLOGIES, INC., Austin, TX (US)

(72) Inventors: George Y. GU, Austin, TX (US); Amit PATWARDHAN, Austin, TX (US); Guanyu MA, Austin, TX (US); Michael Z. HU, Austin, TX (US); Teague M. EGAN, Austin, TX (US)

(73) Assignee: ENERGY EXPLORATION TECHNOLOGIES, INC., Austin, TX (US)

(21) Appl. No.: 18/706,890

(22) PCT Filed: Nov. 2, 2022
(86) PCT No.: PCT/US2022/079122

§ 371 Date: May 2, 2024

Related U.S. Application Data
(60) Provisional application No. 63/274,781, filed on Nov. 2, 2021.

(51) Int. Cl. C02F 1/42; B01D 61/46; B01D 71/28; C02F 103/08

(52) U.S. Cl. CPC C02F 1/42; B01D 61/464; B01D 71/28; B01D 2325/42; C02F 2001/425; C02F 2103/08

(57) ABSTRACT

The present disclosure provides methods of improving the monovalent selectivity of the anion exchange membrane. When operating electrodialysis in a high salinity brine, the high salinity solution enables monovalent selective transport. The monovalent selectivity can significantly retard divalent anion transport, such as SO₄²—, and is particularly useful during lithium extractions from brines. Such selectivity can be utilized in many operation containing high concentration of salt solution such as sea salt extraction, lithium production, and the production of chloroalkanes.

This application claims the benefit of priority to U.S. Provisional Application No. 63/274,781, filed on Nov. 2, 2021, the entire contents of which are hereby incorporated by reference.

### BACKGROUND

### 1. Technical Field

The present disclosure generally relates to ion exchange membranes for use in lithium extraction from natural resources. More specifically, the disclosure relates to monovalent anion selective membranes for use in electrodialysis (“ED”) during lithium extraction. In particular, the present disclosure relates to membranes that show enhanced selectivity when used with solution that show high total dissolved salt (TDS).

### 2. Description of Related Art

Lithium is widely used for many industrial applications including lithium-ion batteries, glasses, greases, and other applications such as metallurgy, pharmaceutical industry, primary aluminum production, organic synthesis, etc. Lithium mining has drawn significant interest due to the recent surge in electrical vehicle (“EV”) market and its increasing forecast. Lithium-ion batteries have so far demonstrated highest energy density and stability for automobile applications. Lithium production is expected to triple between 2021 and 2025 due to the projected growth in EV mobility and grid storage. Most lithium production in past and recent years has been from the so-called lithium triangle comprising the convergence of Chile, Argentina, and Bolivia in South America. Even though the newer production has been coming from hard-rock sources such as spodumene in Western Australia, the dominance of brine-based production is expected to continue into the foreseeable future. In 10-20 years, recycling of lithium from spent batteries is also expected to supplant new production.

Lithium recovery from salt-lake brine has heretofore been a long process that has involved drilling in order to access the sub surface brine deposits, pumping brine to the surface, and brine distribution to solar evaporation ponds where the brine has been concentrated for 18-24 months. During the solar evaporation stage of such a prior art process, sodium, potassium and magnesium chloride salts precipitate before lithium precipitation losses begin. Lithium concentration nevertheless continues to increase as part of this process, sacrificing 40-70% of the contained lithium as a co-precipitate mixed with other less valuable salts. The final concentrated lithium brine is then processed through a series of separation steps involving solvent extraction for boron removal, lime-soda softening for Mg and/or Ca, and heavy metal impurity removal, followed by precipitation with soda ash as lithium carbonate. The crude lithium carbonate is further refined to battery grade or converted to a battery grade lithium hydroxide monohydrate product again involving additional processing steps. A majority of the world's lithium carbonate and hydroxide is currently produced in this fashion.

To prevent the large environmental footprint of solar evaporation ponds, the evaporative loss of water in one of the world's most arid regions, to achieve significantly higher lithium recovery from the resource, and to utilize lower grade lithium resources, Direct Lithium Extraction (“DLE”) has gained significant interest. DLE involves pumping of the subsurface brine and selective separation of Li from all other impurity cations, using selective ion exchange, ion sorption, membrane separation, or solvent extraction, and then returning the lithium depleted brine to the brine pool. Only one commercial application of a combined DLE and solar evaporation pond approach is in production in Argentina today. Due to the increasing focus on sustainability of lithium extraction, a “pure” DLE approach is an eventual certainty. In parallel, suitable separations such between Li⁺ and Mg²⁺, and, Cl⁻ and SO₄²⁻, if applied at the right point in the process, the proven and conventional low recovery solar evaporation process can be enhanced to match the recovery benefits of DLE at a lower cost from existing and even newer operations.

Lithium extraction from ores has typically involved pyrometallurgical and/or hydrometallurgical processes. In the case of lithium salt production from spodumene, lithium concentrate is produced by gravity, heavy media, flotation, and magnetic separation. Afterwards, α-spodumene is converted into β-spodumene at 1070-1090° C. in order to get easier lithium extraction by sulfuric acid at 250° C. The residue is then washed with water at 90° C., in order to dissolve lithium sulphate. Impurities such as iron, aluminum, magnesium, calcium, etc., are removed by precipitation. Crude lithium carbonate is then precipitated with addition of soda ash and further refined to make battery-grade products, as with the brine-based processes. Some ores, such as low-grade hectorite clays, are treated in a similar fashion. Ores such as jadarite require no pyrometallurgical treatment but follow the same hydrometallurgical steps.

Therefore, there remains a need to help develop methods and membranes that may be used in different context to overcome the challenges with high brine solutions while showing improved selectivity for certain types of ions.

### SUMMARY

The desalting and extraction applications also involve nanofiltration (“NF”) for divalent rejection and reverse osmosis (“RO”) for salt concentration. The application is typically for low TDS solutions. In high TDS solution, the pressure driven membrane process including NF and RO becomes difficult. Many desalting processes combine ED with pressure driven process when ED was used at the high-end desalting. As for many applications water recovery is always a concern, the water extraction from high TDS needs to be performed. On the other hand, if ion, such as Li, needs to be extracted a high concentration brine is usually used as direct feed. Both cases here demand a water treatment process dealing with high TDS

Electrodialysis (“ED”) is a membrane process that is generally not limited by high TDS (>3.5%), as is prevalent in lithium brines. In addition, it can facilitate brine concentration simultaneously with impurity ion separation. ED can allow ion separation under the influence of an applied electrical current. Under an electrical potential between the anode and the cathode, the positively charged cations are able to migrate towards the cathode and the negatively charged anions are able to move towards the anode. In an embodiment, the ED module can incorporate cation and anion membranes, alternately arranged. The cation membranes can have anion functional groups, such as —SO₃⁻, immobilized that can prohibit anions passing though, while anion membranes can possess fixed cation groups, such as —NR₃⁺, enabling only anions passing yet preventing passage of cations.

As described earlier, more than two-thirds of the lithium resources in the world reside in the Lithium Triangle. These very high salinity brines include lithium concentrations ranging from 200 ppm-2000 ppm. Lithium in these brines is associated with high levels of Na⁺, K⁺, Mg²⁺, Cl⁻, SO₄²⁻, B (ionic or molecular), and/or other ions. Every brine chemistry is unique. However, they can be broadly classified into high magnesium and high sulfate brines based on their impurity profile. Nearly 80% of these brines can be classified as high sulfate brines. Most of the world's brine-based lithium production is from the 20% low sulfate brines found in Chile. In all cases, major co-precipitation losses of lithium can occur during the evaporation and concentration process. In high magnesium brines, the losses can occur mainly as a lithium carnalite precipitate (LiCl·MgCl₂·7H₂O). In high sulfate brines, losses occur mainly as lithium sulfate monohydrate (Li₂SO₄·H₂O) and lithium schoenite (Li₂SO₄·K₂SO₄). Hence, the ability to separate Li⁺ from Mg²⁺ and Cl⁻ from SO₄²⁻ can increase lithium recovery from these resources by 100-300%. A perfect example is the Bolivian lithium resource which accounts for 25% of the global lithium resource and 40% of the global brine-based lithium resource. No production of lithium at commercial scale has been possible so far because of the very high sulfate content of this resource, in addition to the high magnesium content and relatively low lithium concentration. Ability to separate SO₄²⁻ from Cl⁻ can potentially make this resource economically viable. The elimination of SO₄²⁻ from Cl⁻ is particularly important. This disclosure relates to the separation of these anions from high salinity brines.

Very few separation technologies can successfully operate in these conditions or with brines that have a high salinity exceeding 3.5% TDS. Of those that can, even fewer technologies can separate SO₄²⁻ from Cl⁻ Selective Membrane Electrodialysis (“SME”), particularly using the selective anion exchange membrane described in the present disclosure, can accomplish this separation to help unlock some of the biggest lithium resources in the world.

Monovalent ion selective separation technologies have been applied to desalting operations. These applications include sea salt harvest, irrigation water management, and/or scaling prevention. For pressure driven membranes, it is known that nano filtration (NF) membranes can provide monovalent and multivalent ion separation. All these applications, however, have been limited to treating <5% Total Dissolved Solids (TDS) feeds and concentrating them to <8% TDS.

In lithium brine extraction, ED has shown a superior performance to pressure driven separation technology, including NF, which cannot operate at reasonable and practical pressures in these high TDS brines. High TDS brines here can be defined as brines containing between 5-70% TDS, more typically 10-50% TDS, or even more commonly 15-45% TDS. Monovalent selective ion exchange membranes suitable for ED can include both cation and anion monovalent selective membranes. In lithium brine processing, monovalent cation selectivity between the monovalent Li⁺ and divalent Mg²⁺ can be of particular importance. For irrigation water treatment, monovalent cation selectivity between the monovalent Na⁺ and divalent Mg²⁺ and Ca²⁺ can be of particular importance. The monovalent anion separation of Cl⁻ from divalent SO₄²⁻ can be of particular importance in both lithium brine processing, chloralkali industry and sea salt harvest. Separating monovalent cations and anions from divalent cations and anions can prevent major precipitation losses of valuable lithium during the extraction process. In irrigation water treatment, separation of monovalent Na⁺ separation can result in production of irrigation quality water from poorer quality waters by reducing the sodium adsorption ratio (SAR). In sea salt harvest, the sulfate in seawater is approximately 3000 ppm and needs to be removed during concentrate process.

Several reports have reported success by modifying the membrane into a more hydrophobic nature. There has also been effort made to modify the membrane surface with charged groups that can retard the transport of high valency anions. Both of these modifications can be of use in preparing monovalent selective membranes.

In order to obtain hydrophobicity, in addition to modifying the intrinsic material of the membrane, it can also be effective to change the water content of the membrane material. When membranes encounter a very high salinity, the water content inside the membrane can tend to reduce significantly due osmotic effect. The reduction of a given membrane water content by high concentration brine can be seen by the increase in resistivity of the ion exchange membrane. Table 1 lists the areal resistivity of an anion exchange membrane (AEM) exposed to a high concentration naturally evaporated brine which was sequentially diluted. The brine composition at 48% TDS is shown in Table 1.

TABLE 1
AEM membrane areal resistivity in brine of various concentration

| | 48% TDS | | | | | | |
|---|---|---|---|---|---|---|---|
| | (Raw | 42% | 38% | 35% | 31% | 24% | 3.5% |
| | Brine) | TDS | TDS | TDS | TDS | TDS | TDS |
| AEM (Ω-cm²) | 59 | 32 | 25.1 | 18.9 | 17.2 | 13.6 | 3.0 |

When the interior water content of the membrane is low, the transport for an anion with high hydration energy becomes difficult. Table 2 lists Gibbs hydration energy of several mono and multi valent anions. The present disclosure is to directed to utilizing a phenomenon that a regular anion exchange membrane (AEM) without any further modification and can have a significant monovalent selective transport ability enabled by the high concentration brine solution. Such monovalent anion selectivity can provide an efficient lithium brine purification by elimination of the sulfate ions. In addition, such monovalent and multivalent selectivity enables or enhanced by the high TDS is described herein. In addition to Li extraction, the uses of the membrane example include but not limited to sea salt harvesting and high TDS brine chloralkaline cell separated by a anion membrane to avoid SO₄²⁻ entering certain compartment of the electrochemical cell.

These high TDS brine solutions may be separated using the membranes described herein to create a separation process for Li ions or other another relevant ion. The high selectivity of the TDS solutions when exposed to the anion separation membrane may be knowingly or unknowingly used by skilled artisans.

TABLE 2
Gibbs hydration energy for several anions

| Ion | F⁻ | Cl⁻ | NO₃⁻ | I⁻ | SO₄²⁻ |
|---|---|---|---|---|---|
| Hydration Energy(kJ/mole) | 434 | 317 | 270 | 251 | 1000 |

### BRIEF DESCRIPTION OF THE DRAWINGS

So that the manner in which the features, advantages and objects of the invention, as well as others which may become apparent, are attained and can be understood in more detail, more particular description of the invention briefly summarized above may be had by reference to the embodiment thereof which is illustrated in the appended drawings, which drawings form a part of this specification. It is to be noted, however, that the drawings illustrate only example embodiments of the invention and is therefore not to be considered limiting of its scope as the invention may admit to other equally effective embodiments.

FIG. 1 is a schematic diagram for an ED experiment set up to evaluate the monovalent selectivity of the said membrane, according to one example embodiment of the present disclosure.

FIG. 2 illustrates an ED concentration gain in the receiver (concentrate) reservoir as the function of the ED operation time, with a donor (dilute) concentration maintained at 300 g/L NaCl and 50 g/L NaCl. FIG. 2 also illustrates the membrane used for ED operation in accordance with the present disclosure.

FIG. 3 illustrates a plot of the RTN value derived from equation-1 versus the brine concentration, in accordance with an example implementation of the present disclosure. The brine solutions were prepared with NaCl and Na₂SO₄ with each content (g/L) listed in the X axis.

### DETAILED DESCRIPTION OF THE EMBODIMENTS

The present disclosure relates to methods of using an anion exchange membrane in high brine solutions, wherein the anion exchange membrane results in higher selectivity for monovalent anions as the salinity increases. One of the embodiments is the use of this composition in a DLE. These compositions may be used in separating lithium from a high salt brine solution. The use of a monovalent selective ion exchange membrane may be used to obtains monovalent selective ion during chlor-alkali process. For example, when Cl is extracted or purified for chlor-alkaline industry, the SO₄²⁻ is detrimental to be included in the electrolysis cell. Sulfate which can accumulate in the membrane cell when it is not removed from the recycled brine. The accumulation of sulphate in brine will cause precipitation on the electrode surface in the electrolysis cell, which will increase the energy consumption (higher voltage) and reduce the lifetime of the very expensive electrode and the ion exchange membranes of the membrane cell process for the chloralkali production.

In another embodiment, the methods may be applied to sea salt harvest. When applying ED for sea salt concentrate, it is economical to concentrate the salt to a TDS>10% then evaporate the water. During ED operation, the concentrated stream may be managed for various ED stages to obtain an optimized concentration and multivalent blockage.

Monovalent selective ion exchange membrane can be important in lithium separation to separate monovalent cations such as Li⁺, Na⁺, and K⁺ from multivalent cations such as Mg²⁺ and Ca²⁺. Using selective cation exchange membranes (CEM) can prevent lithium coprecipitation losses, particularly with Mg²⁺ present as part of lithium carnalite (LiCl·MgCl₂·6H₂O). For an anion exchange membrane (AEM), such selectivity can be used to separate Cl⁻, Br⁻, and/or NO₃⁻ from SO₄²⁻ of which SO₄² is responsible for lithium losses by precipitation of such components as Li₂SO₄·H₂O and/or Li₂SO₄·K₂SO₄ during lithium concentration. Originally, selective monovalent AEM technology was applied to sea salt harvest for generating pure NaCl table salt. Recently, monovalent selective cation membrane technology has also been applied to the ground water desalting for irrigation to provide water with and enhanced divalent ion (Mg²⁺ and Ca²⁺) content to reduce the sodium adsorption ratio (SAR) to maintain a healthy soil structure.

Accordingly, one embodiment of this disclosure is to generate an ion exchange membrane with an enhanced monovalent selective nature for use, for example, in processing of high salinity brines. Traditionally, ED was used to treat brackish water, desalting sea water, concentrate process waste water, etc. The TDS for these applications is typically in a range of 1,000 ppm to 200,000 ppm. In lithium extraction from brines, a TDS ranged from 20% to 50% is frequently encountered. As was shown in Table 1, an AEM membrane prepared by aminating vinylbenzylchloride-divinylbenzene (VBC-DVB) polymer film with trimethylamine can have its areal resistivity increase rapidly as the salinity (TDS) increases, an indication of membrane bulk water loss due to the osmotic effect. The membrane here used has a thickness of ˜80-120 μm measured when dry.

It is well understood that the hydration energy for monovalent and multivalent ions is significantly different. Table 2 lists the hydration energy for several anions. Generally, a high hydration energy ion demands more surrounding water molecules in order to form a tighter ion-water “sphere” to be stable. Thus, a lot of attempts have been made to modify the AEM both surface and bulk to make it more hydrophobic and provide for monovalent ion selective transport. When an anion migrates through the AEM, each given positively charged and immobilized exchange site can play a vital role for selective anion transport. The membrane with this charge type nature excludes cation transport. Particularly when the exchange site is modified to be hydrophobic, it can be very effective for monovalent selective or multivalent retarding transport medium. This phenomenon further indicates that the monovalent selectivity is enabled by the low water content medium, and this phenomenon is utilized in the present disclosure. Without wishing to be bound by any theory, it is believed that a low water content improves or enhances the monovalent selectivity of the material.

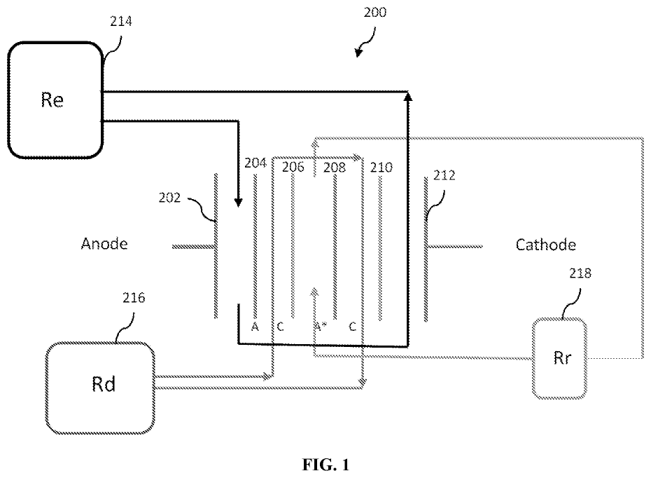

Turning now to the figures, FIG. 1 is a schematic diagram for an ED experiment used to evaluate the monovalent selectivity of the membrane, according to one example embodiment. A membrane can be tested for its selectivity, Cl⁻ ion versus SO₄²⁻ ion, using the electrodialysis (“ED”) device 200, illustrated in FIG. 1. (this paragraph is identical to example 3, please re-consider whether should be here or in example 3) It is to be understood that the above-listed parameters are merely provided as an example, and one skilled in the art may adjust those accordingly, depending on the desired implementation.

### EXPERIMENTAL EXAMPLES

The following experimental examples are meant to illustrate phenomenon for monovalent and multivalent selective AEM for ED application, particularly for hydrometallurgy of lithium.

### Example 1

An AEM was prepared by co-polymerizing vinylbenzylchloride (VBC) and divinylbenzene (DVB). It was then treated with trimethyl amine to form the AEM. The AEM had a thickness of ˜100 μm and water content measured between dry and wet weight of 15-22%. The membrane was also tested for areal resistivity at 0.50 N NaCl and Donnan potential formed by a 0.250 N NaCl and 0.500 N NaCl on either side. Example data is outlined below:
Thickness: 100 μm(dry)
Water content: 19%
Resistivity: 3.1 Ω-cm2
Donnan Potential: 13.7 mV

### Example 2

A lithium brine solution was obtained from a vendor and had its constituent components analysed with the result in mg/L outlined here:

TABLE 3
Lithium Brine Solution

| Mg²⁺ | Li⁺ | Na⁺ | K⁺ | B | Cl⁻ | SO₄²⁻ |
|---|---|---|---|---|---|---|
| 110,000 | 1,200 | 1,500 | 600 | 1,100 | 340,000 | 28,000 |

The said membrane is soaked in the Table 3 brine solution for 3 hours and the resistivity is tested with the same brine solution of soaking. The brine solution was then diluted to various concentration and the resistivity of the membrane in Example 1 was tested in the brine with various dilutions with same procedure. Table 4 lists all the areal resistivities (Ω-cm²) at various concentrations of the brine.

TABLE 4
resistivity of the membrane at various concentrations.

| | | | | | | |
|---|---|---|---|---|---|---|
| Brine TDS | 48.1% | 38.4% | 34.6% | 30.7% | 24% | 3.0% |
| R(Ω-cm²) | 32.8 | 17.13 | 12.7 | 9.05 | 5.74 | 3.0 |

### Example 3

The membrane prepared in Example 1 is typically a circular disk with an area˜10 cm² and is tested in electrodialysis (ED) using a small ED device, such as shown in FIG. 1. The effective area of the membrane for ED is 6.0 cm². In an embodiment, the membrane is tested for its selectivity, Cl⁻ ion versus SO₄²⁻ ion, using the electrodialysis (ED) device illustrated in FIG. 1. The ED device can include six (6) interfacial layers, with each displayed in FIG. 1 sequentially from the left: an anode plate, AEM, CEM, AEM*, CEM, and a cathode plate. The five compartments of the ED 200 are identified in the same sequence from the left: anolyte, dilute (aka donor) compartment circulated by a peristatic pump from reservoir, concentrate (aka receiver) compartment from reservoir 218, dilute compartment from reservoir 216 circulated in series with the dilute compartment with same pump and from the same reservoir 216, and catholyte circulated in series with the anolyte compartment with the same pump and from the same reservoir 214. The AEM as labeled A* in FIG. 1 can be the monovalent selective membrane being tested, while all the other three membranes can be regular ion exchange membranes. In the embodiment, the electrical migration flux area of the cell is approximately 6 cm². A current density of 300 A/m² can be applied between the two electrodes, and the fluids associated with each of the five compartments can be circulated by the peristatic pumps, as shown in FIG. 1. The dilute (donor) stream can be 50 g/L Na₂SO₄ and 300 g/L NaCl with a controlled pH=2.5˜3.5. The concentrate compartment connected to the concentrate (receiver) reservoir (Rr) 218 can be sampled for Cl⁻ and SO₄²⁻ analysis to study the selectivity. The “A C A* C” can be the alternating AEM and CEM arrangement, thereby forming the donor and receiving stream locations. The reservoir for receiver (Rr) 218 and/or donor (Rd) 216 can be analyzed for ion concentrations by an ion chromatograph (IC).

### Example 4

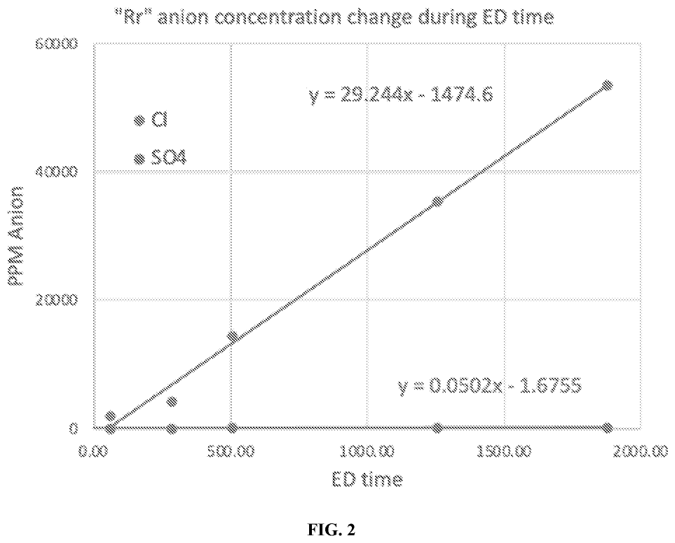

The membrane prepared in Example 1 was tested for its monovalent selectivity using solutions containing NaCl and Na₂SO₄. FIG. 2 shows an ED concentration gain in the receiver (concentrate) reservoir with a donor (dilute) concentration maintained at 300 g/L NaCl and 50 g/L NaCl. The concentration of the ions in the donor reservoir 216 (Rd) are all maintained at a constant value. The concentrate (receiver) reservoir can be started with a very low concentration (˜500 ppm) of NaOH to provide a conductivity needed to carry the current when power is turned on. FIG. 2 also shows the membrane used for an ED operation with a concentrate fed by a 300 g/L NaCl and 50 g/L Na₂SO₄.

The separation factor or specifically here relative transport number (RTN) is defined as:

$$RTN = \frac{Δ {C}^{c l} / {C}^{{SO}_{4}}}{Δ {C}^{{SO}_{4}} / {C}^{{SO}_{4}}} \qquad Equation 1$$

where ΔC^{Cl} and ΔC^{SO4} are respectively the Cl⁻ and SO₄²⁻ ion transported through the membrane or detected in the reservoir 218 of FIG. 1; and C^{Cl} and C^{SO4} are respectively the concentration of Cl⁻ and SO₄²⁻ in reservoir 216 (Rd) where both ion transported from. FIG. 2 shows the ΔC^{Cl} and ΔC^{SO4} concentration change in the receiver reservoir 218 monitored by the ion chromatography (IC) as the function of the ED operation time using the device specified in example-3 and the FIG. 1. To the data displayed in FIG. 2 and the donor reservoir data in table 4 for TDS=35% a RTN value of 108 can be calculated based on the equation 1.

### Example 5

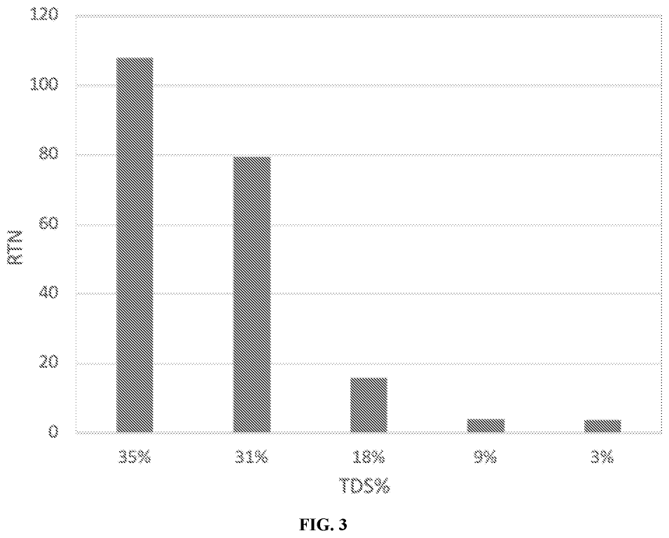

In this example, the membrane was run in the ED testing apparatus with various donor (dilute) concentrations, and the data was plotted in the same fashion as shown in FIG. 2. The slope ratio of the Cl⁻ gain and SO₄²⁻ gain was calculated and the donor concentrations were used to calculate the RTN value for all the experiments using various brine concentrations displayed by the X axis of the FIG. 3. The RTN value was calculated as described in Example 4. The experiment has been extended to various TDS values to present the embodiment of this disclosure and to further support the said method of forming monovalent selective ion transport through an anion exchange membrane.

FIG. 3 is a plot of the RTN value versus the brine concentration. The brine solutions were prepared with NaCl and Na₂SO₄ with each content (g/L) listed in the X axis.

TABLE 5
data relevant to FIG. 3.

| | TDS = | TDS = | TDS = | TDS = | TDS = |
|---|---|---|---|---|---|
| | 35% | 31% | 17.5% | 8.8% | 3% |
| NaCl(g/L) | 300 | 270 | 150 | 75 | 27 |
| Na₂SO₄ | 50 | 45 | 25 | 12.5 | 3 |
| RTN | 108 | 79.4 | 15.9 | 4 | 3.7 |

The Specification, which includes the Summary, Brief Description of the Drawings and the Detailed Description, and the appended Claims refer to particular features (including process or method steps) of the disclosure. Those of skill in the art understand that the present disclosure includes all possible combinations and uses of the particular features described in the Specification. Those of skill in the art understand that the disclosure is not limited to or by the description of embodiments given in the Specification.

The methods and systems of the present disclosure can now be described more fully hereinafter with reference to the accompanying drawings in which embodiments are shown. The methods and systems of the present disclosure may be in many different forms and should not be construed as limited to the illustrated embodiments set forth herein; rather, these embodiments are provided so that this disclosure can be thorough and complete, and can fully convey its scope to those skilled in the art. Like numbers refer to like elements throughout.

Those of skill in the art also understand that the terminology used for describing the particular embodiments does not limit the scope or breadth of the disclosure. In interpreting the Specification and appended Claims, all terms should be interpreted in the broadest possible manner consistent with the context of each term. All technical and scientific terms used in the Specification and appended Claims have the same meaning as commonly understood by one of ordinary skill in the art to which this invention belongs unless defined otherwise.

As used in the Specification and appended Claims, the singular forms “a,” “an,” and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced. The verb “operatively connecting” and its conjugated forms means to complete any type of required junction, including electrical, mechanical or fluid, to form a connection between two or more previously non-joined objects. If a first component is operatively connected to a second component, the connection can occur either directly or through a common connector. “Optionally” and its various forms means that the subsequently described event or circumstance may or may not occur. The description includes instances where the event or circumstance occurs and instances where it does not occur.

Conditional language, such as, among others, “can,” “could,” “might,” or “may,” unless specifically stated otherwise, or otherwise understood within the context as used, is generally intended to convey that some implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

The systems and methods described herein, therefore, are well adapted to carry out the objects and attain the ends and advantages mentioned, as well as others inherent therein. While example embodiments of the system and method have been given for purposes of disclosure, numerous changes exist in the details of procedures for accomplishing the desired results. These and other similar modifications may readily suggest themselves to those skilled in the art, and are intended to be encompassed within the spirit of the system and method disclosed herein and the scope of the appended claims.

What is claimed is:

1. A method of separating a monovalent anion from a multivalent anion from a solution comprising contacting the solution with an electric current causing the current to pass through a membrane component, wherein the membrane component comprises one or more membranes, wherein the solution comprises a total dissolved salt (TDS) amount of at least 5%.

2. The method of claim 1, wherein the monovalent anion is a halide.

3. The method of claim 2, wherein the halide is Cl⁻.

4. The method according to any one of claims 1-3, wherein the multivalent anion is SO₄²⁻.

5. The method according to any one of claims 1-4, wherein the TDS amount of the solution is from about 5% to about 70%.

6. The method of claim 5, wherein the TDS amount is from about 10% to about 50%.

7. The method of claim 6, wherein the TDS amount is from about 15% to about 45%.

8. The method according to any one of claims 1-7, wherein the membrane component comprises one or more anion exchange membranes.

9. The method of claim 8, wherein the anion exchange membrane is a polyvinyl membrane.

10. The method of claim 9, wherein the polyvinyl membrane is substituted with one or more amine groups.

11. The method of claim 11, wherein the amine groups comprise an amine of the formula: —NR′R″R′″, wherein R′, R″, and R′″ are a C1-C30 aliphatic groups.

12. The method of claim 11, wherein R′ is a C1-C18 aliphatic group.

13. The method of claim 12, wherein R′ is a C1-C8 alkyl group.

14. The method according to any one of claims 11-13, wherein R″ is a C1-C18 aliphatic group.

15. The method of claim 14, wherein R″ is a C1-C8 alkyl group.

16. The method according to any one of claims 11-15, wherein R′″ is a C1-C18 aliphatic group.

17. The method of claim 16, wherein R′″ is a C1-C8 alkyl group.

18. The method according to any one of claims 1-17, wherein the membrane component further comprises one or more cation selective membranes.

19. The method according to any one of claims 1-18, wherein the membrane component exhibits a higher relative transport number (RTN) as the TDS of the solution increases.

20. The method of claim 19, wherein the membrane component exhibits an increase in RTN of at least 20% when the TDS is increased by 10%.

21. The method according to any one of claims 1-20, wherein the membrane component has a relative transport number of greater than 5.

22. The method of claim 21, wherein the relative transport number is greater than 10.

23. The method of either claim 21 or claim 22, wherein the relative transport number is greater than 50.

24. The method according to any one of claims 1-23, wherein the solution is a lithium brine.

25. The method according to any one of claims 1-23, wherein the solution is sea water.

26. The method according to any one of claims 1-23, wherein the solution is the result of chloroalkane production.

27. The method according to any one of claims 1-26, wherein the solution further comprises one or more cations.

28. The method of claim 27, wherein the cations are a monovalent or divalent cation.

29. The method of either claim 27 or claim 28, wherein the cation is Na⁺ or Li⁺.

30. The method according to any one of claims 27-29, wherein the cation is Li⁺.

31. The method of either claim 27 or claim 28, wherein the cation is Mg²⁺ or Ca²⁺.

32. A method of separating a monovalent anion from a multivalent anion from a lithium brine solution comprising contacting the lithium brine solution with an electric current causing the current to pass through a membrane component, wherein the membrane component comprises one or more membranes, wherein the lithium brine solution comprises a total dissolved salt (TDS) amount of at least 5%.

33. A method of separating a monovalent anion from a multivalent anion from a sea water solution comprising contacting the sea water solution with an electric current causing the current to pass through a membrane component, wherein the membrane component comprises one or more membranes, wherein the sea water solution comprises a total dissolved salt (TDS) amount of at least 5%.

34. A method of separating a monovalent anion from a multivalent anion from a chloroalkane production solution comprising contacting the chloroalkane production solution with an electric current causing the current to pass through a membrane component, wherein the membrane component comprises one or more membranes, wherein the chloroalkane production solution comprises a total dissolved salt (TDS) amount of at least 5%.
